(19) United States
(12) Patent Application Publication
(10) Pub. No.: US 2017/0166798 A1
(43) Pub. Date: Jun. 15, 2017

(54) DIVERSION SAND AND METHODS

(71) Applicant: FracSolution Technologies, LLC, Houston, TX (US)

(72) Inventors: Kelvin T. Okamoto, Carmel, IN (US); Dwight Smith, Palm Beach Gardens, FL (US); Billy Bennett, Duncan, OK (US)

(73) Assignee: FracSolution Technologies, LLC, Houston, TX (US)

(21) Appl. No.: 15/246,728

(22) Filed: Aug. 25, 2016

Related U.S. Application Data
(60) Provisional application No. 62/309,015, filed on Mar. 16, 2016.
(60) Provisional application No. 62/209,823, filed on Aug. 25, 2015.

(51) Int. Cl. C09K 8/42; E21B 33/14; C04B 20/10; C09K 8/80; C04B 28/02; C04B 14/06; E21B 43/267; C09K 8/62

(52) U.S. Cl. CPC C09K 8/426; E21B 43/267; E21B 33/14; C09K 8/62; C09K 8/805; C04B 28/02; C04B 14/06; C04B 20/1033; E21B 43/26

(57) ABSTRACT

Diversion sand and methods of using the same are described herein. The sand includes particles that have a coating. The coating comprises one or more water dissolvable layer(s).

### RELATED APPLICATIONS

This application claims priority to U.S. Provisional Application No. 62/209,823, filed Aug. 25, 2015 and U.S. Provisional Application No. 62/309,015, filed Mar. 16, 2016, which are incorporated herein by reference in their entirety.

### FIELD

The invention relates to diversion sand and methods of using the same (e.g., in hydrocarbon recovery processes).

### BACKGROUND

Diversion sand may be used in hydrocarbon (e.g., oil, gas) recovery processes as an aid in fracturing operations. For example, diversion sand can be used in an initial fracturing operation or in a re-fracturing operation in which an already fractured well is re-fractured to increase capacity. Diversion sand can be a temporary proppant or blocking agent that stops the flow through existing fractures so that those fractures are not lengthened or do not interfere in the generation of new or additional fractures.

### SUMMARY

Diversion sand and methods of using the same are described herein.

In one aspect, a method is provided. The method comprises introducing a solution comprising diversion sand into a hydrocarbon wellbore. The diversion sand includes particles having a coating. The coating comprises a water dissolvable layer.

In one aspect, a method is provided. The method comprises introducing a solution comprising diversion sand into a hydrocarbon wellbore. The diversion sand includes particles comprising PVOH and/or PVA.

In one aspect, diversion sand is provided. The diversion sand comprises particles having a coating. The coating comprises a water dissolvable layer.

In one aspect, diversion sand is provided. The diversion sand includes particles, wherein the particles comprise PVOH and/or PVA.

Other aspects, features and embodiments are described further below.

### DETAILED DESCRIPTION

Diversion sand and methods of using the same are described herein. In some embodiments, the sand includes particles that have a coating. The coating comprises one or more water dissolvable layer(s). In some embodiments, the particles are not coated and comprise (e.g., formed substantially entirely of) a water dissolvable component such as PVOH and/or PVA. As described further below, the sand may be used in hydrocarbon (e.g., oil, gas) recovery processes (e.g., hydraulic fracturing and re-fracturing methods). For example, during use, the sand may be introduced into a wellbore and can effectively block fractures. After a period of time, the water dissolvable component (e.g., layer(s)) of the diversion sand dissolve, thus, allowing the hydrocarbon (e.g., oil or gas) to pass through the fractures into the wellbore from which it may be recovered.

Suitable diversion sand particles can comprise a mineral (e.g., a natural mineral, a synthetic mineral), inorganic chemical, organic chemical or a polymeric material (e.g., a polymeric bead). Examples of suitable minerals include granite, sand, silica, limestone (e.g., dolomite), magnesium silicate, calcium carbonate, aragonite, talc, and quartz. Other potential suitable particle materials include zeolites. The minerals may be produced through mining, refining or synthetically.

In some embodiments, the particles are substantially insoluble in water. In other embodiments, the particles are water dissolvable.

As noted above, the particles may include a coating. The coating may include a single layer (e.g., the water dissolvable layer), in some embodiments. In other embodiments, the coating may include multiple layers. In multi-layer embodiments, the coating may include multiple water dissolvable layers (e.g., two or more water dissolvable layers that dissolve at different temperatures); or, a single water dissolvable layer in combination with one or more additional layers. In some embodiments, the coating includes one or more layer(s) that are not water dissolvable. In some embodiments, the water dissolvable layer is formed on one or more inner layer(s). The inner layer(s) may comprise a chemical for release after the water dissolvable layer has dissolved. For example, the chemical may be selected from the group consisting of: an antifouling agent, scale inhibitors, biocides, waxes, asphaltene, clay stabilizers, thickening agents, tracers, gel breakers or water migration inhibitors.

In embodiments in which the particles are coated, the coating can include at least one water dissolvable layer. In embodiments, in which the particles are not coated, the particles comprise a water dissolvable component. The term “water dissolvable” refers to a material that substantially dissolves in water at use temperatures and also refers to polymers that depolymerize or react in water at use temperatures with the resultant byproducts being soluble in water. In some embodiments, the water dissolvable material (e.g., layer) dissolves in water at temperatures (i.e., the use temperature) from 10° C. to 180° C.; in some embodiments, the water dissolvable layer dissolves in water at temperatures from 60° C. to 110° C.; in some embodiments, the water dissolvable layer dissolves in water at temperatures from 10° C. to 50° C.; and, in some embodiments, the water dissolvable layer dissolves in water at temperatures from 120° C. to 180° C.

Suitable water dissolvable polymers include polyvinyl alcohol (YVON), polyglycolic acid (PGA), and polytrimethylene terephthalate (PTT). Water dissolvable polymers that depolymerize or react in water to produce byproducts that are soluble in water at use temperatures include many thermoplastic polyesters and polyamides, such as polylactic acid (PLA), polybutylene succinate (PBS), polybutylene adipate terephalate (PBAT) and polybutylene adipate succinate (PBAS). Polyvinyl acetate (PVA) is an example of a polymer that reacts in water at use temperatures to produce water soluble byproducts. It should be understood that the water dissolvable materials may also be blended in any combination to produce a water dissolvable layer for the diversion sand.

The coating and/or water dissolvable layer may be present at any suitable weight percentage. In some embodiments, the weight percentage (as compared to the total weight of the sand) is between 1% and 20% in some embodiments, between 1.5% and 10%; and, in some embodiments, between 2.0% and 7.5%.

In some embodiments, the water dissolvable layer(s) are also biodegradable in water. Water biodegradability can be determined using standard test methods of ASTM, CEN, ISO or other accepted standards bodies. In general, biodegradability is determined in water by having over 90% of the organic carbon converted to carbon dioxide or methane within one year in the biodegradation environment.

As noted above, the water dissolvable layer may comprise a polymeric material. The polymeric materials may be a thermoplastic that is produced from any combination of monomers or low molecular weight precursors that can produce a water dissolvable polymer. The polymers can be produced by any chemical means known such as a condensation reaction or a radical polymerization with and without catalysts in both instances. The thermoplastic polymer or combination of thermoplastic polymers may be among amorphous, semicrystalline or crystalline polymers. The polymeric materials may also be virgin, scrap, post-industrial recycled or post-consumer material.

In some embodiments, it may be preferred that the water dissolvable material comprises polyvinyl alcohol (PVOH). In embodiments in which the particles are coated, the water dissolvable layer can comprise PVOH. In embodiments in which the particles are not coated, the particles themselves can comprise PVOH. In some embodiments, the particles may be formed substantially of PVOH. Polyvinyl alcohols can have atactic, isotactic, heterotactic and syndiotactic stereospecificity. Changes in the stereospecificity of polyvinyl alcohol affect thermal resistance, crystallinity, melting point, the rate of water dissolvability^{,} and biodegradability. Polyvinyl alcohol comprises vinyl alcohol units and, in some embodiments, consists essentially of vinyl alcohol units. In some embodiments, PVOH is part of a co-polymer material that comprises PVOH and at least one other polymer type. There are no specific limitations with respect to the process for producing the polyvinyl alcohol used in the diversion sand described herein.

Polyvinyl alcohol may also be partially or fully functionalized to produce a polymer that is also water dissolvable. For example, PVOH may be reacted with acetic acid or an equivalent to produce polyvinyl acetate (PVA).

In some embodiments, the water dissolvable material comprises PLA. In embodiments in which the particles are coated, the water dissolvable material can comprise PLA. In embodiments in which the particles are not coated, the particles themselves can comprise PLA. In some embodiments, the particles may be formed substantially of PLA. PLA can be prepared according to any method known in the state of the art. For example, PLA can be prepared from lactic acid and/or from one or more of D-lactide (e.g., a dilactone, or a cyclic dimer of D-lactic acid), L-lactide (e.g., a dilactone, or a cyclic dimer of L-lactic acid), meso D,L-lactide (e.g., a cyclic dimer of D- and L-lactic acid), and racemic D,L-lactide (e.g., racemic D,L-lactide comprises a 1/1 mixture of D- and L-lactide).

PLA can also be nucleated using mineral fillers or other polymers including highly stereospecific (e.g., >95% D) PLA polymers to dramatically increase the thermal resistance of PLA by having the material be semi-crystalline or crystalline rather than be amorphous.

In some embodiments, the polymeric materials described herein may include other components. For example, the diversion sand may include a compatibilizer that can be used to aid two or more polymers to mix together. Compatibilizers can also be binders to adhere the polymers or polymer blends to the mineral filler. As used herein, the term “compatibilizer” means a material that can provide blending between two or more polymers or between one or more polymers and mineral. For example, the compatibilizer can be maleic anhydride grafted polypropylene, glycidyl grafted polypropylene, maleic anhydride grafted polyethylene, maleic anhydride grafted polybutene or combinations thereof. In some embodiments, the compatibilizer can comprise maleated polypropylene, e.g., with a melt flow of about 50 to about 500 g/10 minute and maleic anhydride grafting of about 0.5 to about 10 wt %.

Some non-limitative examples of suitable compatibilizers include Epolene® E-43 (maleated polypropylene), Epolene G-3003 (maleated polypropylene), Epolene G-3015 (maleated polypropylene), Epolene C-16 (maleated polyethylene), and Epolene C-18 (maleated polyethylene). The Epolene series of polymer waxes and polymers is commercially available from Eastman Chemical Company, in Kingsport, Tenn. Epolene polymers are medium to low molecular weight polyethylene or polypropylene. Numerous types of Epolene polymers are available, and properties can be selected to fit various processing operations.

Further non-limitative examples of suitable compatibilizers include Polybond® 1001, Polybond® 1002, Polybond® 1009, Polybond® 3000, Polybond® 3002, Polybond® 3009, Polybond® 3150, and Polybond® 3200. The Polybond® series is commercially available from Chemtura, USA, and are polypropylenes and/or polyethylenes functionalized with maleic anhydride. Polybond® 3150 has a MFI of 50 g/10 min, 230° C., 2.16 kg; and Polybond® 3200 has a MFI of 110 g/10 min, 190° C., 2.16 kg.

In another embodiment, the polymer compositions of the present disclosure can include formulations that are modified with one or more plasticizers, flow promoters, polymer processing aids, slip agents, viscosity modifiers, chain extenders, nanoparticles, spherical glass beads, organic fillers, inorganic fillers, fibers, colorants, anti-microbial agents and the like. The additional components can be added to the polymer composition at any suitable time in the manufacturing process.

The plasticizers can be, for example, any suitable material that softens and/or adds flexibility to the materials to which they are added. For example, the plasticizers can soften. the final product increasing its flexibility. Non-limiting examples of suitable plasticizers include, for example, polyethylene glycol, sorbitol, glycerine, soybean oil, caster oil, TWEEN 20, TWEEN 40, TWEEN 60, TWEEN 80, TWEEN 85, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, polymeric plasticizers such as poly(1,6-hexamethylene adipate) or combination thereof.

In some embodiments, the polymers include chain extenders. For example, the chain extenders can be oligomeric chain extenders. Preferred oligomeric chain extenders include styrene-acrylic copolymers or oligomers containing glycidyl groups incorporated as side chains. Several useful examples are described in the International Patent Application WO 03/066704 A1 assigned to Johnson Polymer, LLC. These materials are based on oligomers with styrene and acrylate building blocks that have desirable glycidyl groups incorporated as side chains. Some embodiments include a high number of epoxy groups per oligomer chain such as at least about 10; in some embodiments, greater than about 15; and, in some embodiments, greater than about 20. These polymeric materials may have a molecular weight greater than about 3000; in some embodiments, greater than about 4000; and, in some embodiments, greater than about 6000. Some examples are commercially available from Johnson Polymer, LLC under the JONCRYL® trade name such as JONCRYL® ADR 4368. Another additive from Arkema Inc, Biostrength™ 700 can also enhance melt strength of the materials of the present disclosure. Biostrength™ 700 is an acrylic based copolymer.

In some embodiments, the polymeric materials described herein may include a filler. Non-limiting examples of organic fillers include wood flour, seeds, polymeric particles, ungelatinized starch granules, cork, gelatins, wood flour, saw dust, milled polymeric materials, agar-based materials, and the like. Examples of inorganic fillers include calcium carbonate, titanium dioxide, silica, talc, mica, sand, gravel, crushed rock, bauxite, granite, limestone, sandstone, glass beads, aerogels, xerogels, clay, alumina, kaolin, microspheres, hollow glass spheres, porous ceramic spheres, gypsum dihydrate, insoluble salts, magnesium carbonate, calcium hydroxide, calcium aluminate, magnesium carbonate, ceramic materials, pozzolanic materials, salts, zirconium compounds, xonotlite (a crystalline calcium silicate gel), lightweight expanded clays, perlite, vermiculite, hydrated or unhydrated hydraulic cement particles, pumice, zeolites, exfoliated rock, ores, minerals, and the like. A wide variety of other inorganic fillers may be added as starting materials to the polymeric materials including, for example, metals and metal alloys (e.g., stainless steel, iron, and copper), balls or hollow spherical materials (such as glass, polymers, and metals), filings, pellets, flakes and powders (such as microsilica).

Non-limiting examples of fibers that may be incorporated into the polymer compositions include naturally occurring organic fibers, such as cellulosic fibers extracted from wood, plant leaves, and plant stems. These organic fibers can be derived from cotton, wood fibers (both hardwood or softwood fibers, examples of which include southern hardwood and southern pine), flax, abaca, sisal, ramie, hemp, and bagasse. In addition, inorganic fibers made from glass, graphite, silica, ceramic, rock wool, or metal materials may also be used.

Non-limiting examples of anti-microbial agents include metal-based agents such as zinc oxide, copper and copper compounds, silver and silver compounds, colloidal silver, silver nitrate, silver sulfate, silver chloride, silver complexes, metal-containing zeolites, surface-modified metal-containing zeolites or combination thereof. The metal-containing zeolites can include a metal such as silver, copper, zinc, mercury, tin, lead, bismuth, cadmium, chromium, cobalt, nickel, zirconium or a combination thereof. In another embodiment, the anti-microbial agents can be organic-based agents such as o-benzyl-phenol, 2-benzyl-4-chloro-phenol, 2,4,4′-trichloro-2′-hydroxydiphenyl ether, 4,4′-dichloro-2-hydroxydiphenyl ether, 5-chloro-2-hydroxy-diphenyl-methane, mono-chloro-o-benzyl-phenol, 2,2′-methylenbis-(4-chloro-phenol), 2,4,6-trichlorophenol or a combination thereof.

In one embodiment, the diversion sand may also include one or more typical process aids used in hydraulic fracturing, such as water thickeners, rust inhibitors and flow aids. The process aid may be in the coating of the diversion sand and would be released as the water dissolvable layer dissolves.

In some embodiments, the diversion sand has a density of greater than 1.25 g/cc.

In general, the diversion sand has any suitable particle size to perform sufficiently during use. In some embodiments, the diversion sand has a particle size from 10 to 250 US mesh size; in some embodiments, the particle size is from 20 to 40 US mesh size; in some embodiments, the particle size is from 30 to 70 US mesh size; and in some embodiments, the particle size is from 100 to 250 US mesh size.

Advantageously, the diversion sand described herein can be stable (e.g., thermally stable). For example, the sand may be shelf stable to 60° C. In some cases, the diversion sand does not require temperature-controlled environments for shipping.

In some cases, the diversion sand is water dissolvable at room temperature. For example, the diversion sand may be completely water dissolvable.

In certain embodiments, during use, the diversion sand is blended with one or more additional components. The components are selected from the group consisting of expandable polymeric beads, non-expandable polymer beads, and uncoated mineral. In some embodiments, diversion sand blends may also be produced. For instance, the blends may be produced by mixing different particles coated with different one or more water dissolvable layers. As an example, a diversion sand blend may be produced by blending PVOH coated dolomitic limestone with PLA coated frac sand.

The diversion sand may be produced by any means known. Potential manufacturing methods include melt or liquid addition of the polymeric coating to the mineral in a screw conveyor, in a pug mill, in a mixer (e.g. a double planetary mixer) or in spray dry coating. The liquid addition can be neat or by using any solvent but preferably water. Following the addition of coating to the mineral, the diversion sand may be dried prior to addition to the hydraulic fracturing solution though this may not be necessary. The produced diversion sand may also undergo size classification and deagglomeration for better performance downwell. For better adhesion, the mineral may also be pre-heated prior to the liquid or melt addition of the polymer coating.

As described above, the diversion sand may be used in hydrocarbon (e.g., oil, gas) recovery processes (e.g., hydraulic fracturing and re-fracturing methods). For example, during use, the sand may be introduced into a wellbore. In some embodiments, the diversion sand is introduced into the wellbore along with a solution (e.g., a water solution). The solution may be a fluid mixture of solid components in a fluid (e.g., water). The diversion sand may be used in hydraulic fracturing and re-fracturing processes to temporarily block open fractures (including cracks, channels and the like) to allow new fractures or to extend other unblocked fractures to be lengthened, branched or widened to increase the flow of hydrocarbon (e.g., oil, natural gas or other petroleum products) out of the well. The diversion sand may be added alone or in combination with standard proppants including uncoated and coated frac sand and coated and uncoated synthetic proppants (e.g. ceramic proppants).

In hydraulic fracturing, diversion sand may be used after the initial fracturing operation to allow more fracturing to occur, especially after a poor fracture in one or more well zones. In this case, the all zones may be initially fractured or only some fractured before a zone is isolated for additional fracturing. To do this, the zone to be further fractured may be isolated by any means and the diversion sand sent downwell. The zone would then be further fractured by any means followed by the at least one or more water dissolvable coatings and possibly the particle core dissolving. Standard proppant may be sent downwell before, during or after the diversion sand dissolution process. This process is repeated for all zones that require additional fracturing.

In a general embodiment, a method for fracturing or re-fracturing oil wells that uses diversion sand with one or more water dissolvable coating layers around a particle core is provided wherein the diversion sand is added to the water solution injected into the well followed by the diversion sand then agglomerating and plugging the fractures in the far field or near well bore. The well is then further fractured and the one or more layers of the diversion sand dissolve in the water solution injected into the well.

In certain hydraulic re-fracturing processes, the process is similar as for hydraulic fracturing but is performed on wells that have already been in production for months to years. Thus, standard proppant is not typically sent downwell first and instead diversion sand is typically sent down after the first step of zone isolation.

In some embodiments, the diversion sand particles are used during a cementing operation. For example, a fluid mixture that includes the diversion sand particles and cement may be used in an operation that involves cementing the hydrocarbon well. In some cases, the diversion sand particles may be used for masking during the cementing operation. The cementing operation may involve placing cement in an area between a casing and the wellbore.

1. A method comprising:
introducing a solution comprising diversion sand into a hydrocarbon wellbore, wherein the diversion sand includes particles having a coating, the coating comprising a water dissolvable layer.

2. A method comprising introducing a solution comprising diversion sand into a hydrocarbon wellbore, wherein the diversion sand includes particles comprising PVOH and/or PVA.

3. Diversion sand comprising particles having a coating, the coating comprising a water dissolvable layer.

4. Diversion sand including particles, wherein the particles comprise PVOH and/or PVA.

5. The method of claim 1, further comprising adding diversion sand to a water solution to form the solution that is introduced into the hydrocarbon wellbore.

6. The method of claim 1, further comprising plugging fractures in the hydrocarbon well with the diversion sand.

7. The method of claim 1, further comprising re-fracturing the well to create additional fractures.

8. The method of claim 1, further comprising dissolving the water dissolvable layer to unplug the fractures.

9. The method of claim 1, further comprising dissolving the PVOH and/or PVA to unplug the fractures.

10. The method of claim 1, wherein the hydrocarbon wellbore is an oil wellbore.

11. The method of claim 1, wherein the solution comprises a fluid mixture.

12. The method of claim 1, wherein the fluid mixture comprises cement.

13. The method of claim 1, wherein the fluid mixture comprises water.

14. The method of claim 1, further comprising cementing the hydrocarbon wellbore.

15. The method of claim 1, wherein the diversion particles are used for masking during hydrocarbon well cementing.

16. The method of claim 1, wherein cementing the hydrocarbon wellbore includes placing cement in an area between a casing and the wellbore.

17. The method or of claim 1, wherein the water dissolvable layer is biodegradable.

18. The method of claim 1, wherein the particle is substantially insoluble in water.

19. The method of claim 1, wherein the particle comprises a mineral.

20. The method of claim 1, wherein the particle comprises limestone, calcium carbonate, sand or talc.

21.-46. (canceled)
